(19) United States
(12) Patent Application Publication
(10) Pub. No.: US 2026/0136093 A1
(43) Pub. Date: May 14, 2026

(54) ACCESSORY, IMAGE PICKUP APPARATUS, CONTROL METHOD, AND STORAGE MEDIUM

(71) Applicant: CANON KABUSHIKI KAISHA, Tokyo (JP)

(72) Inventor: KAZUTO SUZUKI, Kanagawa (JP)

(21) Appl. No.: 19/368,355

(22) Filed: Oct. 24, 2025

(30) Foreign Application Priority Data
Nov. 12, 2024 (JP) 2024-197090

(51) Int. Cl. H04N 23/663; G03B 17/56

(52) U.S. Cl. CPC H04N 23/663; G03B 17/56

(57) ABSTRACT

An accessory is connectable to an image pickup apparatus and includes an operation member operable by a user, one or more memories storing instructions, and one or more processors that, upon execution of the instructions, operate to control the accessory according to an operation of the operation member, transmit information on the accessory to the image pickup apparatus, and receive setting information transmitted from the image pickup apparatus based on the information. The setting information is used to make a setting regarding a control of the accessory.

### BACKGROUND

### Field of the Technology

The aspect of the disclosure relates to one or more embodiments of an accessory, an image pickup apparatus, a control method, and a storage medium.

### Description of the Related Art

Accessories attachable to an image pickup apparatus include a variety of types, and various settings of the image pickup apparatus are made for each attached accessory based on ID information on that accessory (see Japanese Patent Applications Laid-Open Nos. 2000-075384 and 2005-173314).

### SUMMARY

One or more embodiments of an accessory according to one or more aspects of the disclosure may be connectable to an image pickup apparatus and include an operation member operable by a user, one or more memories storing instructions, and one or more processors that, upon execution of the instructions, operate to control the accessory according to an operation of the operation member, transmit information on the accessory to the image pickup apparatus, and receive setting information transmitted from the image pickup apparatus based on the information. The setting information is used to make a setting regarding a control of the accessory. A control method for the above accessory and a storage medium storing a program that causes a computer to execute the above control method also constitute another aspect of the disclosure.

One or more embodiments of an image pickup apparatus according to one or more aspects of the disclosure may be connectable to an accessory that is controllable according to an operation of an operation member and include one or more memories storing instructions, and one or more processors that, upon execution of the instructions, operate to perform a setting regarding a control of the accessory based on information on the accessory received from the accessory, and transmit setting information to the accessory for the accessory to make the setting. A control method for the above image pickup apparatus and a storage medium storing a program that causes a computer to execute the above control method also constitute another aspect of the disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating the basic configuration of a lens, a camera body, and an adapter in this embodiment.

FIG. 2 illustrates a menu for lens control settings in the embodiment.

FIG. 3 illustrates power zoom speed information for each lens model in this embodiment.

FIG. 4 is a flowchart illustrating processing according to the first embodiment.

FIG. 5 is a flowchart illustrating other processing according to the first embodiment.

FIG. 6 is a flowchart illustrating processing according to a second embodiment.

FIG. 7 is a flowchart illustrating processing according to a third embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a description will be given of embodiments according to the disclosure.

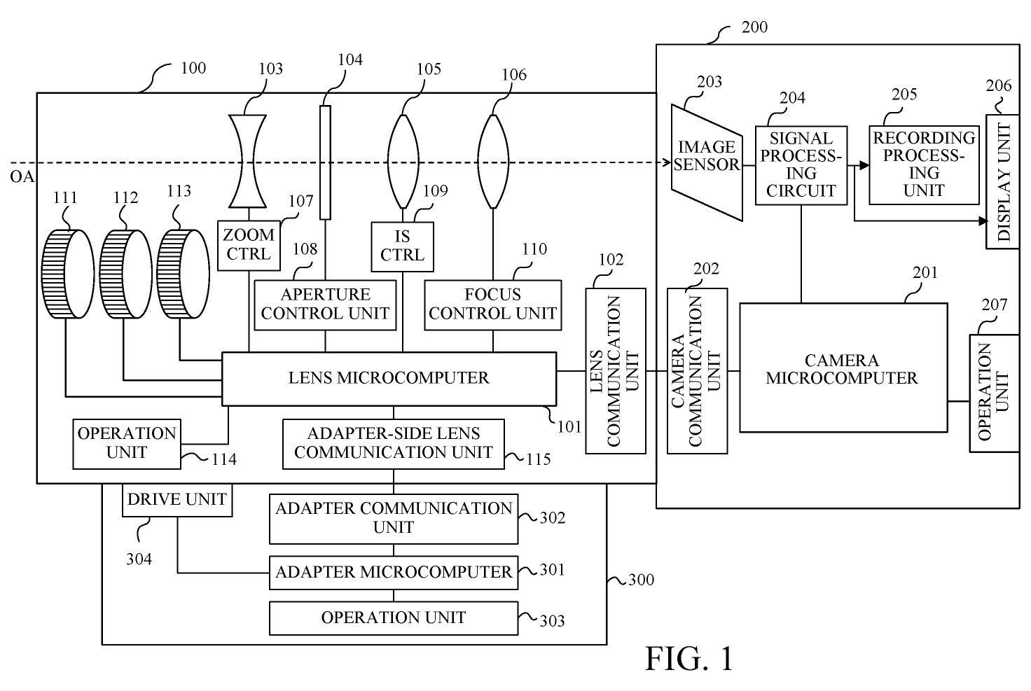

FIG. 1 illustrates the configuration of an imaging system including a lens apparatus (optical apparatus; simply referred to as a lens hereinafter) as an accessory according to this embodiment of the disclosure. The imaging system includes a lens 100, a camera body 200 as an image pickup apparatus to which the lens 100 is detachably and communicatively attached (connected), and an adapter 300 as an accessory detachably and communicatively attached to the lens 100.

In the conventional imaging system, when an accessory is attached to the camera body, a setting regarding the camera body stored in the camera body or the accessory is applied to the camera body based on the ID (identification) information on the accessory. In the conventional imaging system, no settings regarding accessory control are performed.

In a case where the camera body does not support the setting regarding the accessory control, it cannot perform the setting regarding the accessory control. For example, in a case where an accessory that can change the power zoom speed from the camera body is attached to a camera body that does not support a change in the power zoom speed, the camera body cannot perform the setting regarding the control suitable for that accessory.

In a case where an accessory is attached to a camera body for the first time and there are no settings regarding accessory control stored in either the camera body or the accessory, the user may make setting regarding accessory control in the camera body or the accessory before starting imaging.

Accordingly, this embodiment provides an accessory that allows setting regarding accessory control to be made according to the attachment of the accessory to the camera body.

In FIG. 1, the lens 100 includes an imaging optical system that includes a zoom lens 103, an aperture (stop) unit 104, an image stabilizing lens 105, and a focus lens 106. The lens 100 is mechanically and electrically connected to the camera body 200 via an unillustrated mount. The lens 100 receives power supply from the camera body 200 via an unillustrated power supply terminal provided on the mount, which causes a lens microcomputer 101, which serves as a control unit means, to operate and various actuators to be driven. The camera body 200 can also communicate with the lens microcomputer 101 via a camera communication unit 202 and lens communication unit 102 provided in the mount, and can send control commands to the lens microcomputer 101 to control the lens 100. A more detailed configuration of the lens 100 will be described later.

The adapter 300 is mechanically and electrically connected to the lens 100 via an unillustrated mount. The adapter 300 receives power supply from the camera body 200 via an unillustrated power terminal provided in the mount, and from an external battery connected to the adapter 300. The adapter 300 can communicate with the lens 100 via the adapter communication unit 302 and adapter-side lens communication unit 115 provided in the mount, and can control the lens 100 by sending control commands to the lens microcomputer 101.

The adapter microcomputer 301 is a computer having a control circuit such as a CPU and an adapter memory which is a memory such as a RAM, a ROM, and/or an EEPROM, and controls the operation of the adapter 300 according to a computer program. More specifically, the adapter microcomputer 301 controls a drive unit (controlled unit) 304 according to user operation on an operation unit 303 provided on the adapter 300. The drive unit 304 transmits drive force to an operation member such as an operation ring provided on the lens 100 via a power transmission member such as a gear. This performs lens drive such as zoom drive of the zoom lens 103. The adapter microcomputer 301 also transmits control commands to the lens microcomputer 101 according to user operation on the operation unit 303.

The camera body 200 includes a camera microcomputer 201 which serves as a setting unit, an image sensor 203 which functions as a phase-difference focus-detection sensor, a signal processing circuit 204, a recording processing unit 205, a display unit 206, and an operation unit 207. The camera microcomputer 201 is a computer that has a control circuit such as a CPU and a camera memory, which is a memory such as a RAM, a ROM, and/or an EEPROM (not illustrated), and controls the camera body 200 (and further the lens 100 and adapter 300) according to a computer program. The camera microcomputer 201 also communicates with the lens microcomputer 101 via the camera communication unit 202 and the lens communication unit 102. More specifically, the camera microcomputer 201 transmits and receives various information, such as ID information for the camera body 200 and the lens 100, to and from the lens microcomputer 101. The ID information is information about accessories for identifying the model and individual components of the camera body 200 and the lens 100, and includes the model name and serial number, etc.

The camera microcomputer 201 also transmits to the lens microcomputer 101 control commands regarding the zoom operation of the zoom lens 103 according to the user operation on the operation unit 207, and control commands regarding the light intensity adjustment operation of the aperture unit 104 according to luminance information acquired from a digital imaging signal (described later). The camera microcomputer 201 transmits to the lens microcomputer 101 a control command regarding the focus operation of the focus lens 106 that corresponds to the defocus information acquired from the digital imaging signal.

The camera microcomputer 201 transmits to the lens microcomputer 101 information that causes the lens microcomputer 101 to perform the setting regarding the control of the lens 100 when the operation units 207 or 303 provided on the lens 100 or adapter 300 are operated. The camera microcomputer 201 may store a variety of settings (information on the settings) in association with accessory information such as ID information on the lens 100 or adapter 300 received from the lens microcomputer 101.

The camera microcomputer 201 controls the camera body 200 and the lens 100 according to the operations of a variety of operation members included in the operation unit 207, such as an imaging instruction switch, an aperture setting dial, a shutter speed setting dial, and a zoom lever.

The image sensor 203 photoelectrically converts (captures) an object image formed by the imaging optical system and outputs an analog imaging signal. The analog imaging signal is converted into a digital imaging signal by an A/D conversion circuit (not illustrated). The signal processing circuit 204 performs various image processing for the digital imaging signal to generate a video signal. The video signal is output to the display unit 206. The display unit 206 displays a live-view image based on the video signal.

The signal processing circuit 204 then outputs the video signal to the recording processing unit 205. The recording processing unit 205 stores the video signal in an external memory or the like as still or moving image data. The signal processing circuit 204 also generates defocus information for an object image by the phase-difference focus-detection method using the digital imaging signal, and generates luminance information indicating the luminance of the object image from the video signal.

In addition to the live-view image, the display unit 206 displays menus regarding the settings of the camera body 200, lens 100, and adapter 300.

The configuration of the lens 100 will now be described further. The lens 100 includes the lens microcomputer 101, a zoom operation ring 111, a focus operation ring 112, and an aperture operation ring 113, each of which serves as an operation member, and an operation unit 114. The lens microcomputer 101 is a computer having a control circuit such as a CPU and a lens memory, which is a memory such as a RAM, a ROM, or an EEPROM (not illustrated), and controls the lens 100 according to a computer program. The lens microcomputer 101 also has a time measurement function. The lens memory stores optical data and lens adjustment data corresponding to the state of the imaging optical system, such as the positions of the zoom lens 103, aperture unit 104, and focus lens 106, as data tables. The lens microcomputer 101 performs various controls using data from the data tables according to the current state of the imaging optical system.

The lens microcomputer 101 also receives ID information (information about the accessory) and control commands regarding a zoom operation, a light intensity adjustment operation, and a focus operation from the adapter microcomputer 301 via the adapter-side lens communication unit 115. The lens microcomputer 101 also transmits optical data, lens adjustment data, and information indicating the operational status of the operation members and operation unit 114 of the lens 100 to the adapter microcomputer 301. The lens microcomputer 101 may also transmit ID information obtained from the adapter 300 to the camera microcomputer 201.

The lens microcomputer 101 also receives control commands regarding the zoom operation, light intensity adjustment, and focus operation from the camera microcomputer 201, and receives a request to send optical data, lens adjustment data, and information indicating the operational status of the operation members and operation unit 114 of the lens 100. The lens microcomputer 101 also receives lens setting information from the camera microcomputer 201 as information for a setting the control of the lens 100 (hereinafter referred to as a lens control setting). The camera microcomputer 201 associates the lens control setting for the attached lens 100 with the ID information on the lens 100 and stores it in the camera memory as the past lens control setting.

The lens microcomputer 101 changes the control method for the various actuators within the lens 100, the control method when various operation members are operated, and the control setting when the operation unit 114 is operated, in accordance with the received lens setting information. The lens microcomputer 101 saves the lens control settings indicated by the lens setting information received from the camera microcomputer 201 in the lens memory. The lens microcomputer 101 also transmits the lens setting information to the adapter microcomputer 301. The adapter microcomputer 301 saves the lens control setting indicated by the lens setting information received from the lens microcomputer 101 in the adapter memory.

When the lens microcomputer 101 receives the control command regarding zoom operation, light intensity adjustment, and focus operation, it controls a zoom drive unit 107, aperture driver 108, and focus drive unit 110, which are respectively controlled units, in accordance with the control command. This drives the zoom lens 103, aperture unit 104, and focus lens 106, performing zooming, light intensity adjustment, and focusing (AF) of the imaging optical system.

The lens microcomputer 101 also controls the focus drive unit 110 in accordance with an operation amount of the focus operation ring 112 to drive the focus lens 106, thereby enabling manual focusing. The lens microcomputer 101 controls the aperture driver 108 in accordance with the operation amount of the aperture operation ring 113 to drive the aperture unit 104, thereby enabling manual light amount adjustment. The lens microcomputer 101 also controls the zoom drive unit 107 in accordance with the operation amount of the zoom operation ring 111 to drive the zoom lens 103, thereby enabling manual zooming (referred to as power zooming hereinafter).

Each operation ring may be of a type in which it is operated from a reference position, an operation amount from the reference position is detected, and its position returns to the reference position when the operation ends, or may be of a type in which a rotation amount and a rotation speed from the position at the start of operation may be detected as the operation amount.

The lens microcomputer 101 can change a drive amount, a drive speed, a drive direction, etc. of the zoom lens 103, aperture unit 104, or focus lens 106 when each operation ring is operated, in accordance with the lens control setting indicated by the lens setting information received from the camera microcomputer 201. Similarly, the adapter microcomputer 301 can change the control command sent to the lens microcomputer 101 when the operation unit 303 is operated, in accordance with the lens control setting indicated by the lens setting information received from the lens microcomputer 101. This allows for a fine setting corresponding to the operation amount of each operation ring and the operation of each operation unit.

The zoom lens 103 can move in the direction of the optical axis OA of the imaging optical system, indicated by a broken line in FIG. 1 (referred to as an optical axis direction hereinafter), and its position is detected by an unillustrated position sensor such as a photo-interrupter. Information about the position of the zoom lens 103 is output to the lens microcomputer 101. The zoom drive unit 107 drives a zoom actuator such as a stepping motor or vibration motor to move the zoom lens 103 according to a command from the lens microcomputer 101. The aperture unit 104 can change an aperture diameter (aperture value or F-number) by moving a plurality of aperture blades in the opening and closing directions, and the aperture value is detected by a magnetic sensor such as an unillustrated Hall element. Aperture value information is output to the lens microcomputer 101. The aperture driver 108 drives an aperture actuator such as a stepping motor to move the aperture blades according to a command from the lens microcomputer 101.

The image stabilizing lens 105 reduces (corrects) image blur caused by camera shake such as hand shake by moving in a direction orthogonal to the optical axis OA. An image stabilizing drive unit 109 drives an image stabilizing actuator to move the image stabilizing lens 105 according to camera shake detected by an unillustrated shake sensor such as a vibration gyro, based on a command from the lens microcomputer 101.

The focus lens 106 is movable in the optical axis direction, and the position of the focus lens 106 is detected by a position sensor such as a photo-interrupter (not illustrated). Information about the position of the focus lens 106 is output to the lens microcomputer 101. The focus drive unit 110 drives a focus actuator such as a stepping motor or vibration motor according to a command from the lens microcomputer 101 to move the focus lens 106. The position of the focus lens 106 is controlled to correct image plane fluctuations that occur during zooming due to the movement of the zoom lens 103.

The operation unit 114 includes operation members such as switches, and issues a control instruction to the lens microcomputer 101 according to the user operation. The lens microcomputer 101 notifies the camera microcomputer 201 of the operation of the operation unit 114. The control performed when the operation unit 114 is operated can be changed according to the lens setting information received from the camera microcomputer 201.

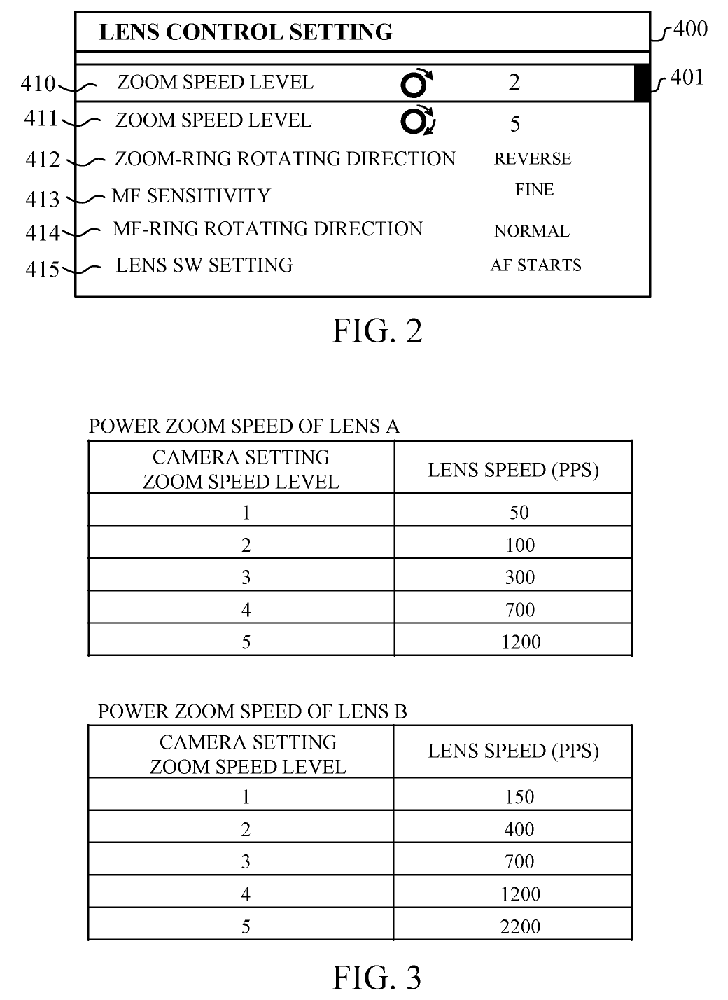

FIG. 2 illustrates a menu 400 for a lens control setting, displayed on the display unit 206 of the camera body 200. The user performs the lens control setting by operating the operation unit 207 on the camera body 200 while viewing the menu 400. A selection area 401 in the menu 400 indicates the lens control setting that the user is currently configuring.

Zoom speed levels 410 and 411 indicate the drive speed settings of the zoom lens 103 when the zoom operation ring 111 on the lens 100 is operated. The zoom speed level 410 indicates the drive speed setting (2 in the figure) of the zoom lens 103 when the operation amount (operation speed) of the zoom operation ring 111 is small, while the zoom speed level 411 indicates the drive speed setting (5 in the figure) of the zoom lens 103 when the operation amount of the zoom operation ring 111 is large. The speed level can be set in five steps, with 1 being the minimum speed and 5 being the maximum speed. The speed level values 1 to 5 are merely illustrative, and the actual drive speed may be used instead of the speed level.

A zoom ring rotation direction 412 indicates a drive direction of the zoom lens 103 when the zoom operation ring 111 is operated. For example, it is possible to set "normal," which moves the zoom lens 103 toward the telephoto side according to the clockwise rotation of the zoom operation ring 111, or "reverse," which moves the zoom lens 103 toward the wide-angle side.

A manual focus (MF) sensitivity 413 indicates the setting for the drive amount of the focus lens 106 per unit operation amount of the focus operation ring 112. For example, it is possible to set "fine," which has a small drive amount of the focus lens 106 (a change amount in the focus state) per unit operation amount of the focus operation ring 112, or "normal," which has a drive amount of the focus lens 106 larger than that of “fine.” A moving distance may be set according to the rotation speed of the focus operation ring 112, or according to the rotation angle of the focus operation ring 112.

An MF-ring rotating direction 414 indicates the setting for the drive direction of the focus lens 106 when the focus operation ring 112 is operated. For example, it is possible to set "normal," which drives the focus lens 106 toward a close distance according to the clockwise rotation of the focus operation ring 112, and "reverse," which drives the focus lens 106 toward infinity.

A lens SW setting 415 indicates the control setting that the lens 100 is to perform according to the turning-on operation of a specific switch (operation member) on the operation unit 114. As illustrated in the figure, in a case where the "AF starts" is set, the control that the lens 100 is to perform according to the turning-on operation is to have the lens microcomputer 101 notify the camera microcomputer 201 that the turning-on operation has been performed. This causes the camera microcomputer 201 to start the AF control. Alternatively, the control that the lens 100 is to perform according to the turning-on operation of a specific switch may cause the lens microcomputer 101 to perform the preset control that moves the zoom lens 103, focus lens 106, or aperture unit 104 to a predetermined position.

The above setting items are illustrative, and other setting items may be provided. The lens control setting may also be made according to the operation of the operation member of the adapter 300.

The camera microcomputer 201 sends lens setting information indicating the lens control setting changed through the menu 400 to the lens microcomputer 101. However, the supported lens control setting varies according to the model of the camera body 200. For example, in a case where the camera body 200 does not support the lens control setting regarding zooming of the lens 100, it is not possible to set the zoom speed levels 410 and 411 and the zoom ring rotation direction 412.

In this case, the lens microcomputer 101 does not receive the lens control setting regarding zooming from the camera microcomputer 201, so zooming is performed using the lens control setting that is set by default in the lens 100 or that is stored in the lens microcomputer 101.

FIG. 3 illustrates the power zoom speeds pps (pulse/sec) corresponding to the zoom speed levels 410 and 411 for each model (A or B) of the lens attached to the camera body 200. The lens microcomputer 101 drives the zoom lens 103 at the power zoom speed corresponding to the zoom speed level received from the camera microcomputer 201. Since the weight of the zoom lens 103 and the characteristic of the zoom actuator differ for each lens model, the actual driven speed of the zoom lens 103 differs for each lens model, even if the received zoom speed level is the same. The lens microcomputer 101 may transmit to the camera microcomputer 201 power zoom speeds corresponding to the zoom speed levels 410 and 411.

FIG. 3 expresses the power zoom speed as pps, but another expression may be used. FIG. 3 illustrates the power zoom speed, but may be the focus speed during manual focusing, for example. While FIG. 3 illustrates five-step power zoom speeds, a power zoom speed other than five levels may be set.

### FIRST EMBODIMENT

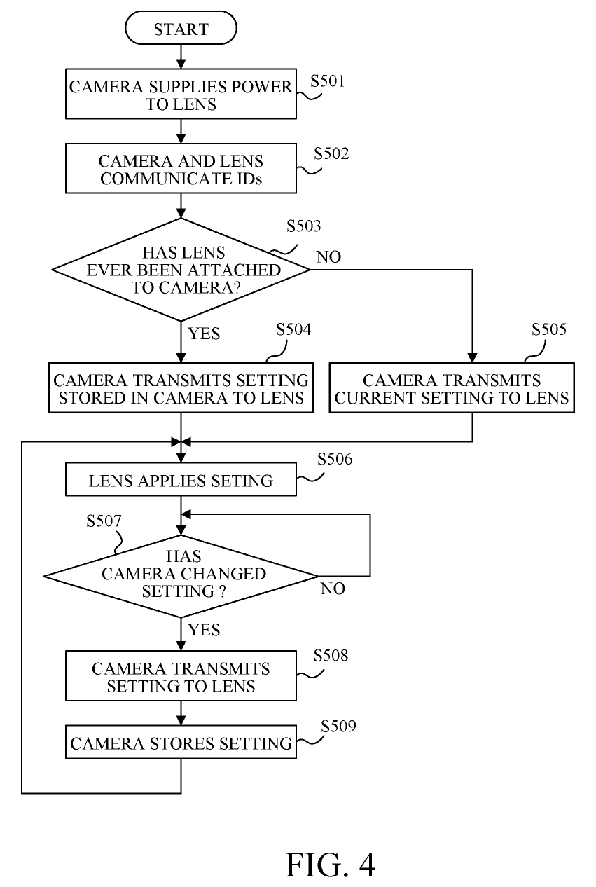

A flowchart in FIG. 4 illustrates processing (control method) in which the camera microcomputer 201 transmits lens setting information to the lens microcomputer 101 based on ID information received from the lens 100 so as to apply the lens control setting corresponding to the lens setting information to the lens 100.

In step S501, the camera body 200 supplies power to the lens 100. In step S502, the camera microcomputer 201 and lens microcomputer 101 communicate ID information (accessory information) of the camera body 200 and lens 100 with each other.

Next, in step S503, the camera microcomputer 201 determines whether the lens 100 has ever been attached to the camera body 200, based on the ID information received from the lens 100. In a case where the lens 100 has ever been attached to the camera body 200, the camera microcomputer 201 performs the processing of step S504; otherwise, the camera microcomputer 201 performs the processing of step S505.

In step S504, the camera microcomputer 201 transmits lens setting information indicating the lens control setting associated with the ID information on the lens 100 and stored in the camera memory to the lens microcomputer 101. The camera microcomputer 201 then performs the processing of step S506.

In steps S502 to S504, accessory information that is separate from the ID information on the lens 100 and that can identify the lens 100 attached to the camera body 200 may be used.

In step S505, the camera microcomputer 201 sends lens setting information indicating the lens control setting currently set in the camera body 200 to the lens microcomputer 101, as there are no lens control settings stored in association with the ID information on the lens 100. Then, the processing of step S506 is performed.

In step S506, the lens microcomputer 101 applies the lens control setting indicated in the lens setting information received from the camera microcomputer 201, as the setting for the lens 100.

Next, in step S507, the camera microcomputer 201 determines whether the lens control setting has been changed by the user in the camera body 200. In a case where the lens control setting has been changed, the processing of step S508 is performed; otherwise, the processing waits for the lens control setting to be changed.

In step S508, the camera microcomputer 201 transmits lens setting information indicating the changed lens control setting to the lens microcomputer 101. The lens microcomputer 101 applies the changed lens control setting indicated in the lens setting information received from the camera microcomputer 201, as the setting for the lens 100.

In step S509, the camera microcomputer 201 associates the changed lens control setting with the ID information on the lens 100 and stores it in the camera memory. The flow returns to step S506.

According to the processing in FIG. 4, the camera microcomputer 201 can apply the lens control setting for the lens 100 that has ever been attached to the camera body 200, to the lens 100 the next time that the lens 100 is attached to the camera body 200.

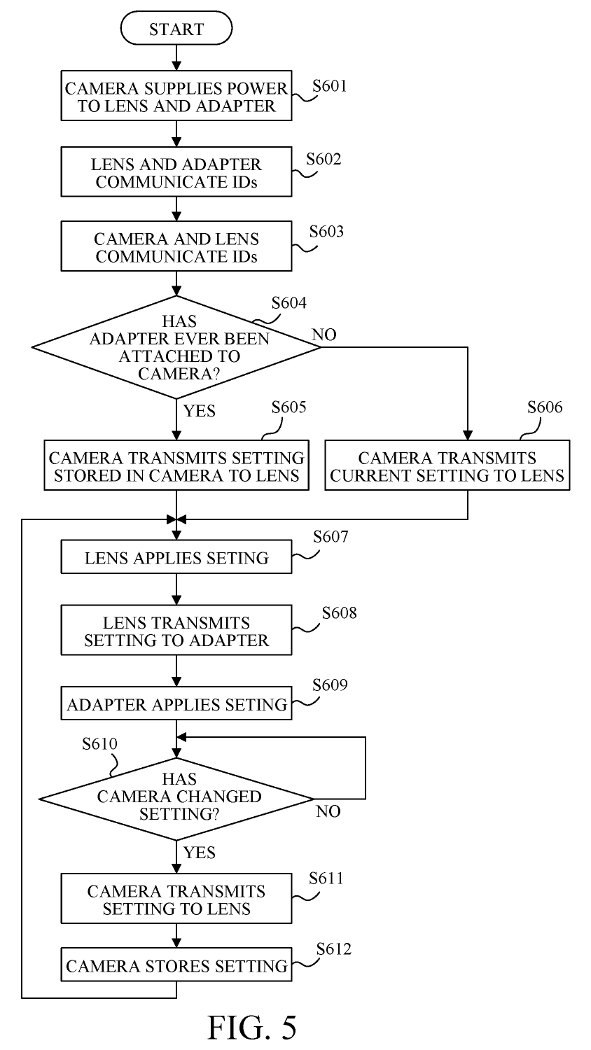

In the processing in FIG. 4, the lens control setting transmitted from the camera body 200 is applied to the lens 100 as an accessory. However, lens control setting transmitted from the camera body 200 may also be applied to the lens 100 and the adapter 300 as another accessory. A flowchart in FIG. 5 illustrates the processing in which the camera body 200 performs the lens control setting for the added adapter 300 and applies the lens control setting to the adapter 300.

In step S601, the camera body 200 supplies power to the lens 100 and adapter 300. In step S602, the lens microcomputer 101 and adapter microcomputer 301 communicate ID information for the lens 100 and adapter 300 with each other.

Next, in step S603, the camera microcomputer 201 and lens microcomputer 101 communicate ID information for the camera body 200, lens 100, and adapter 300 with each other.

Next, in step S604, the camera microcomputer 201 determines, based on the received ID information for the adapter 300, whether the adapter 300 has ever been connected to the camera body 200 (attached to the lens 100). In a case where the adapter 300 has ever been connected to the camera body 200, the processing of step S605 is performed; otherwise, the processing of step S606 is performed.

In step S605, the camera microcomputer 201 transmits lens setting information indicating the lens control setting stored in the camera memory in association with the ID information on the adapter 300, to the lens microcomputer 101. Then, the processing of step S607 is performed. In steps S603 to S605, accessory information that is separate from the ID information on the adapter 300 and that can identify the adapter 300 connected to the camera body 200 may be used.

In step S606, since there are no lens control settings stored in association with the ID information on the adapter 300, the camera microcomputer 201 transmits the lens setting information indicating the lens control setting currently set in the camera body 200 to the lens microcomputer 101. Then, the processing of step S607 is performed.

In step S607, the lens microcomputer 101 applies the lens control setting indicated in the lens setting information received from the camera microcomputer 201, as the setting for the lens 100.

Next, in step S608, the lens microcomputer 101 transmits the lens control settings indicated in the lens setting information received from the camera microcomputer 201, to the adapter 300.

Then, in step S609, the adapter microcomputer 301 applies the lens control settings indicated in the lens setting information received from the camera microcomputer 201, as the setting in the adapter 300.

Next, in step S610, the camera microcomputer 201 determines whether the lens control setting has been changed by the user in the camera body 200. In a case where the lens control setting has been changed, the flow proceeds to step S611, and in a case where the lens control setting has not been changed, the camera microcomputer 201 waits for the lens control setting to be changed.

In step S611, the camera microcomputer 201 transmits lens setting instruction information indicating the changed lens control setting to the lens microcomputer 101. The lens microcomputer 101 applies the changed lens control setting indicated in the lens setting instruction information received from the camera microcomputer 201, as the setting in the lens 100. The lens microcomputer 101 also transmits the lens setting instruction information indicating the changed lens control setting to the adapter microcomputer 301. The adapter microcomputer 301 applies the changed lens control setting indicated in the lens setting instruction information received from the camera microcomputer 201, as the setting for the adapter 300.

In step S612, the camera microcomputer 201 associates the changed lens control setting with the ID information on the adapter 300 and stores it in the camera memory. The flow returns to step S607.

According to the processing in FIG. 5, the camera microcomputer 201 can apply the lens control setting for the adapter 300 that has been connected to the camera body 200 in the past, to the adapter 300 the next time that adapter 300 is connected to the camera body 200.

The lens control setting may also be changed in a similar manner when the adapter 300 is attached to the lens 100 that is activated by receiving power supply from the camera body 200.

The camera body 200 may be configured to set which of the stored lens control setting to apply in a case where both the lens 100 and the adapter 300 have been connected to the camera body 200 in the past. The camera body 200 may be configured to select whether to change the lens control setting in a case where the lens 100 and the adapter 300 are attached to the camera body 200.

### SECOND EMBODIMENT

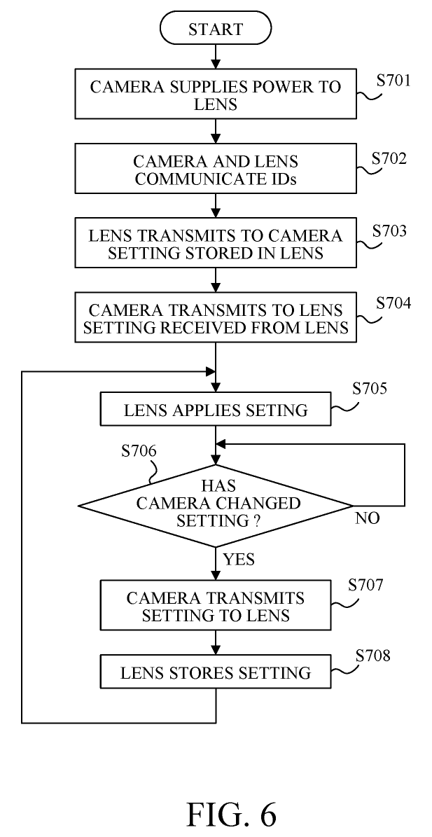

A flowchart in FIG. 6 illustrates the processing of maintaining the lens control setting for the lens 100 even when the lens 100 is attached to a different model of camera body (another image pickup apparatus) by the lens 100 sending lens setting information indicating the lens control setting stored in the lens memory to the camera body 200. The camera body 200 has the same configuration regardless of a model, and common components will be designated by the same reference numerals as in FIG. 1.

In step S701, in a case where the camera body 200, which serves as another image pickup apparatus, supplies power to the lens 100, the camera microcomputer 201 and the lens microcomputer 101 communicate ID information for the camera body 200 and the lens 100 with each other in step S702.

Next, in step S703, the lens microcomputer 101 transmits information indicating the lens control setting, which is information on the accessory stored in the lens memory, to the camera microcomputer 201. At this time, in a case where the lens 100 has never been attached to the camera body 200 in the past, default lens control setting may be transmitted to the camera microcomputer 201. Along with the lens control setting, information indicating setting regarding the camera body 200 (for example, exposure (Tv/ISO), color (color temperature/picture control), imaging setting (AF/continuous shooting/bracket), and various other settings (communication/power saving)) may also be transmitted to the camera microcomputer 201. The processing of step S703 is similarly performed even when the lens 100 is reattached to the camera body 200 that originally transmitted the lens control setting stored in the lens memory to the lens microcomputer 101.

Next, in step S704, the camera microcomputer 201 transmits the lens setting information received from the lens microcomputer 101 to the lens microcomputer 101. This prevents inconsistencies in the lens control setting between the camera body 200 and the lens 100.

Next, in step S705, the lens microcomputer 101 applies the lens control setting indicated in the lens setting information received from the camera microcomputer 201, as the setting for the lens 100.

Next, in step S706, the camera microcomputer 201 determines whether the lens control setting has been changed by the user in the camera body 200. In a case where the lens control setting has been changed, the processing of step S707 is performed; otherwise, the camera microcomputer 201 waits for the lens control settings to be changed.

In step S708, the camera microcomputer 201 transmits lens setting information indicating the changed lens control setting to the lens microcomputer 101. The lens microcomputer 101 applies the changed lens control setting indicated in the lens setting information received from the camera microcomputer 201, as the setting for the lens 100.

In step S708, the lens microcomputer 101 stores the changed lens control setting in the lens memory. The flow then returns to step S705.

According to the processing of FIG. 6, the lens control setting stored in the lens 100 can be applied to various models of camera bodies and lenses 100.

The information indicating the lens control setting that the lens microcomputer 101 transmits to the camera microcomputer 201 in step S703 may be stored in the lens memory in association with the ID information on the camera body 200 communicated in step S702. At this time, in step S705, the lens microcomputer 101 may independently apply lens control setting item that it did not transmit to the camera microcomputer 201 in step S703. This allows the lens 100 to independently apply a setting regarding the setting items that the camera body 200 does not support.

### THIRD EMBODIMENT

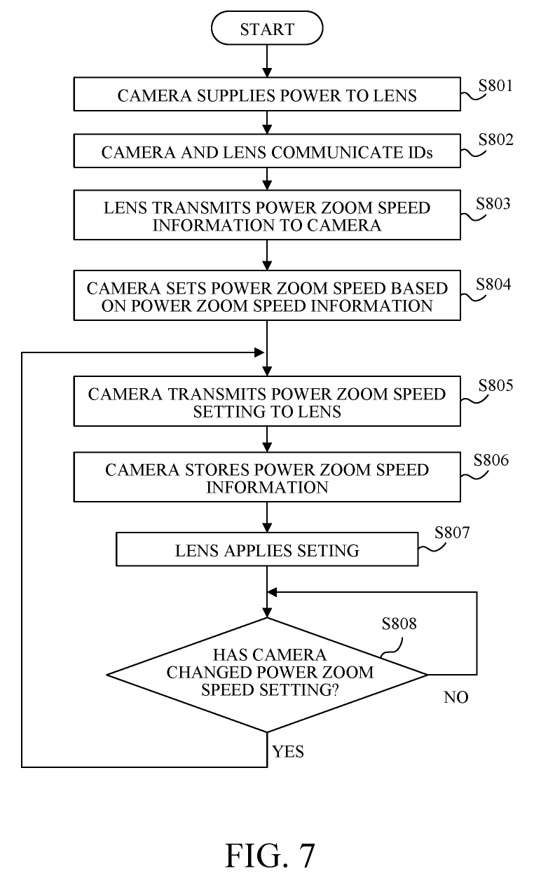

A flowchart in FIG. 7 illustrates the processing in which the lens 100 transmits power zoom speed information as accessory-related information (information on accessory control) to the camera body 200, and the camera body 200 sets the power zoom speed.

In step S801, the camera body 200 supplies power to the lens 100, and in step S802, the camera microcomputer 201 and lens microcomputer 101 communicate ID information for the camera body 200 and lens 100 with each other.

Next, in step S803, the lens microcomputer 101 transmits the power zoom speed information on the lens 100 to the camera microcomputer 201. The power zoom speed information transmitted here is information indicating the lens speed corresponding to zoom speed levels 1 to 5 that can be set in the camera body 200, as illustrated in FIG. 3.

Next, in step S804, the camera microcomputer 201 sets a power zoom speed that corresponds to the zoom speed level set in the camera body 200, from the received power zoom speed information.

Next, in step S805, the camera microcomputer 201 transmits the set power zoom speed to the lens microcomputer 101.

Next, in step S806, the camera microcomputer 201 stores the determined power zoom speed or all of the power zoom speed information received in step S803 in the camera memory.

Next, in step S807, the lens microcomputer 101 applies the power zoom speed received from the camera microcomputer 201.

Next, in step S808, the camera microcomputer 201 determines whether the user has changed the zoom speed level setting. In a case where the setting has been changed, the processing of step S809 is performed; in a case where the setting has not been changed, the flow waits for the setting to be changed.

In the processing in FIG. 7, the camera body 200 can set the power zoom speed based on the power zoom speed information transmitted from the lens 100.

As illustrated in FIG. 3, the power zoom speed information differs for each lens model. In a case where lens A has been attached to the camera body 200 in the past and lens B (another accessory) is now attached to the camera body 200, in step

S804 the camera microcomputer 201 compares the power zoom speed of lens A stored in the camera memory with the power zoom speed received from lens B. The power zoom speed of lens B is then set to the speed closest to the power zoom speed of lens A. For example, in a case where the power zoom speed of lens A is 300 pps, the power zoom speed of lens B is set to 400 pps, or the power zoom speed of lens A is 700 pps, the power zoom speed of lens B is also set to 700 pps. In this way, the lens control setting is made for lens B based on the lens control setting for lens A, and the lens control setting is transmitted to lens B and applied. Thereby, the user may not set the power zoom speed whenever the lens 100 is changed.

The power zoom speed has been set in FIG. 7, but settings other than the power zoom speed, such as a focus speed, may also be similarly set.

### OTHER EMBODIMENTS

Embodiment(s) of the disclosure can also be realized by a computer of a system or apparatus that reads out and executes computer-executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each embodiment according to the disclosure provides an accessory attachable to an image pickup apparatus that can perform a setting regarding the accessory control.

This application claims the benefit of Japanese Patent Application No. 2024-197090, which was filed on November 12, 2024, and which is hereby incorporated by reference herein in its entirety.

What is claimed is:

1. An accessory connectable to an image pickup apparatus, the accessory comprising:
an operation member operable by a user;
one or more memories storing instructions; and
one or more processors that, upon execution of the instructions, operate to:
control the accessory according to an operation of the operation member,
transmit information on the accessory to the image pickup apparatus, and
receive setting information transmitted from the image pickup apparatus based on the information,
wherein the setting information is used to make a setting regarding a control of the accessory.

2. The accessory according to claim 1, wherein the one or more processors operate to apply the setting according to the setting information received from the image pickup apparatus, to the control of the accessory.

3. The accessory according to claim 1, further comprising an optical system, and a drive unit configured to drive the optical system, and
wherein the setting relates to a drive speed, drive direction, or drive amount of the drive unit according to the operation of the operation member.

4. The accessory according to claim 1, wherein the accessory is an adapter attachable to an optical apparatus including an optical system, and includes a drive unit configured to drive the optical system, and
wherein the setting relates to a drive speed, drive direction, or drive amount of the drive unit according to operation of the operation member.

5. The accessory according to claim 1, wherein the information on the accessory includes information that allows the image pickup apparatus to identify the accessory.

6. The accessory according to claim 1, wherein the one or more memories store the setting received from the image pickup apparatus, and
wherein the information on the accessory includes information indicating the setting stored in the one or more memories.

7. The accessory according to claim 6, wherein the one or more processors operate to transmit the information indicating the setting stored in the one or more memories to the image pickup apparatus or another image pickup apparatus connected to the accessory after the setting has been stored in the one or more memories.

8. The accessory according to claim 1, wherein the one or more memories store information on the control, and
wherein the information on the accessory includes information on the control stored in the one or more memories.

9. The accessory according to claim 1, wherein in a case where the setting in the image pickup apparatus is changed, the one or more processors operate to receive from the image pickup apparatus the setting information indicating a changed setting.

10. An image pickup apparatus connectable to an accessory that is controllable according to an operation of an operation member, the image pickup apparatus comprising:
one or more memories storing instructions; and
one or more processors that, upon execution of the instructions, operate to:
perform a setting regarding a control of the accessory based on information on the accessory received from the accessory, and
transmit setting information to the accessory for the accessory to make the setting.

11. The image pickup apparatus according to claim 10, wherein the one or more memories store the setting, and
wherein in a case where the accessory is attached to the image pickup apparatus after the setting has been stored in the one or more memories, the one or more processors operate to transmit to the accessory the setting information indicating the setting stored in the one or more memories.

12. The image pickup apparatus according to claim 10, wherein the information on the accessory includes information that allows the image pickup apparatus to identify the accessory.

13. The image pickup apparatus according to claim 10, wherein the information on the accessory includes information on the setting stored in the accessory.

14. The image pickup apparatus according to claim 10, wherein the information on the accessory includes information on the control of the accessory.

15. The image pickup apparatus according to claim 14, wherein the one or more memories store the setting for the accessory, and
wherein in a case where another accessory is connected to the image pickup apparatus after the setting has been stored in the one or more memories, the one or more processors operate to perform the setting for the other accessory based on the setting stored in the one or more memories and transmit the setting information indicating the settings to the other accessory.

16. The image pickup apparatus according to claim 10, wherein in a case where the setting is changed in the image pickup apparatus, the one or more processors operate to transmit setting instruction information indicating a changed setting to the accessory.

17. A control method for an accessory that includes an operation member operable by a user and is connectable to an image pickup apparatus, the control method comprising:
controlling the accessory according to an operation of the operation member;
transmitting information on the accessory to the image pickup apparatus; and
receiving setting information transmitted from the image pickup apparatus based on the information,
wherein the setting information is used to make a setting regarding a control of the accessory.

18. A control method for an image pickup apparatus connectable to an accessory that is controlled according to an operation of an operation member, the control method comprising:
receiving information on the accessory from the accessory;
performing a setting regarding a control of the accessory based on the information; and
transmitting setting information to the accessory for the accessory to make the settings.

19. A non-transitory computer-readable storage medium storing a program that causes a computer to execute the control method according to claim 17.

20. A non-transitory computer-readable storage medium storing a program that causes a computer to execute the control method according to claim 18.
